(19) United States
(12) Patent Application Publication
(10) Pub. No.: US 2009/0138473 A1
(43) Pub. Date: May 28, 2009

(54) APPARATUS AND METHOD FOR RETRIEVING STRUCTURED DOCUMENTS

(75) Inventors: Toshihiko Manabe, Kamakura-shi (JP); Tomoharu Kokubu, Yokohama-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Kabushiki Kaisha Toshiba

(21) Appl. No.: 12/205,636

(22) Filed: Sep. 5, 2008

(30) Foreign Application Priority Data
Nov. 22, 2007 (JP) 2007-303305

(51) Int. Cl. G06F 17/30

(52) U.S. Cl. 707/7; 707/E17.044

(57) ABSTRACT

An apparatus for retrieving structured documents includes a first categorizing unit configured to categorize components into a first component of typical descriptions and a second component of atypical descriptions, based on statistics information for the components, a second categorizing unit configured to categorize the terms into a first term whose appearance ratio in the first component exceeds a threshold and a second term whose appearance ratio in the first component is not more than the threshold, an extraction unit configured to extract a set of structured documents each having the first component including the first term and the second component from the structured documents, and a ranking unit configured to rank the set of structured documents by a retrieval score calculating based o a relation between the second term and the second component.

### CROSS-REFERENCE TO RELATED APPLICATIONS

This application is based upon and claims the benefit of priority from prior Japanese Patent Application No. 2007-303305, filed Nov. 22, 2007, the entire contents of which are incorporated herein by reference.

### BACKGROUND OF THE INVENTION

1. Field of the Invention

The present invention is related to an apparatus and method for retrieving a desired document from a plurality of structured documents each including a plurality of components.

2. Description of the Related Art

Owing to the progress in information communication technologies, such as the internet, nowadays, it is possible to easily retrieve necessary data from electronic data of a great volume of information. Meanwhile, because of the great volume of information, necessary information may be lost in the vast amount of data and cannot be retrieved at will, thereby, causing a downside that data cannot be utilized sufficiently.

In order to overcome such downside, researches are carried out to organize electronic data into structured documents to facilitate commoditizing information or to further expedite retrieving information. For example, HTML (Hypertext Markup Language) is written by a plurality of components, such as a document title, a header or a paragraph, defined by a tag.

Further, XML (extensible Markup Language), which has gathered attention in recent years, is able to define this tag independently, therefore, excels HTML in flexibility and extensibility. By writing the tag hierarchically, XML is able to express a document structure in a tree structure.

For the structured document of this XML and the like, a query language which has a sentence structure similar to SQL (Structured Query Language) and is able to write a retrieval portion, retrieval condition and information extraction portion etc. is provided. These query languages are defined for the purpose of specifying the component on which to focus in accordance with an established construction to retrieve data/document accurately. For this reason, a user is not only required to understand the data structure of the retrieval target, but also is required to have skills to construct a correct retrieval condition.

Meanwhile, research and development of an information retrieval technique to retrieve documents based on a query of any keywords or natural sentences has conventionally been carried out, so that the documents can be retrieved without causing the user to be conscious of a certain sentence structure. In general, a retrieval score representing a relation between the query and document is calculated, and the retrieval result is ranked in the order of the retrieval score from high to low (descending order).

Generally, a retrieval term which is a term used for retrieval is extracted from the query by using a technique such as a morphological analysis, and a retrieval score is obtained based on statistics information of, such as, the number of documents the term appears in or the number of times the term appears in each document. However, in some cases, when such ranking retrieval technique is applied directly to the structured document, typical data portions, such as bibliographical information, may disturb the retrieval score from being calculated correctly.

For example, there is a technique known to obtain related terms of a query from top-ranked documents of the retrieval result and perform further retrieval not only to retrieve the term in the query but also to retrieve related information over a wide range. However, in some cases, if documents of the same author converge on top-ranked documents, the name of the author may be obtained as a related term, which may negatively affect the retrieval result.

Correspondingly, as a scheme to handle the structured document by an information retrieval technique in which the query is a keyword or sentence form, there are two typical examples as follows.

(1) A scheme to convert the query into a form of a query language, such as an SQL, by using techniques such as a syntax analysis, then executing it.

(2) A scheme to adjust the retrieval score in accordance with the position of term appearance, i.e., to define important components in advance and, in the case where the term appears in the position, to increase the retrieval score, etc.

With regard to (1), it is necessary to establish a knowledge base for converting the query into a query language in advance, such as, knowledge related to the structure of target data. With regard to (2), it is necessary to define a knowledge of, such as, which portion is important, in advance. As in the manners above, in both (1) and (2), it is necessary to prepare a new knowledge each time the target data/document is changed. Further, since (1) targets accurate retrieval (of 0 or 1), it does not support a ranking retrieval which is based on unclear conditions, such as in sentence form.

For example, JP-A 2004-164104 (KOKAI) proposes a technique to perform data retrieval which is similar to the case of using a query language from the keyword or sentence form query, by analyzing and estimating the type of data of a component in advance and without having to prepare special knowledge beforehand. However, likewise the scheme of (1), this technique is not designed to support the ranking retrieval. Further, with this method, there are problems that it would be necessary to designate a component which is to be the retrieval target during the query, and that the method only supports presumable types of data.

Further, JP-A 2003-99454 (KOKAI) proposes a technique to estimate the type of component using layout information of a document. However, there is a problem that it cannot support a structured document which has no layout information.

As mentioned above, when retrieving structured documents by a scheme using query language, a user is not only required to understand the document structure of the retrieval target but is also required to have skills to construct correct retrieval conditions. Further, in a scheme which performs retrieval based on a keyword or sentence form, it is necessary to define knowledge related to target data/documents in advance. Further, an existing retrieval apparatus supports only either the query language type retrieval or the ranking retrieval, and is unable to perform flexible retrieval which combines the two types of retrievals.

### BRIEF SUMMARY OF THE INVENTION

In accordance with a first aspect of the invention, there is provided an apparatus for retrieving a plurality of structured documents each comprising a plurality of components including text data includes a first categorizing unit configured to categorize the components into a first component of typical descriptions and a second component of atypical descriptions, based on statistics information for the components; an input unit configured to input a retrieval character string including a plurality of terms; a second categorizing unit configured to categorize the terms into a first term whose appearance ratio in the first component exceeds a threshold and a second term whose appearance ratio in the first component is not more than the threshold; a document set extraction unit configured to extract a set of structured documents each having the first component including the first term and the second component from the plurality of structured documents; and a ranking unit configured to rank the set of structured documents by a retrieval score calculating based on a relation between the second term and the second component.

Further, In accordance with a second aspect of the invention, there is provided a method for retrieving a plurality of structured documents each comprising a plurality of components including text data includes categorizing the components into a first component of typical descriptions and a second component of atypical descriptions, based on statistics information for the components; inputting a retrieval character string including a plurality of terms; categorizing the terms into a first term whose appearance ratio in the first component exceeds a threshold and a second term whose appearance ratio in the first component is not more than the threshold; extracting a set of structured documents each having the first component including the first term and the second component from the plurality of structured documents; and ranking of the set of structured documents by a retrieval score calculating based on a relation between the second term and the second component.

In accordance with a third aspect of the invention, there is provided a computer readable storage medium storing instructions of a computer program for retrieving a plurality of structured documents each comprising a plurality of components including text data, which when executed by a computer results in performance of steps includes categorizing the components into a first component of typical descriptions and a second component of atypical descriptions, based on statistics information for each of the components; inputting a retrieval character string including a plurality of terms; categorizing the terms into a first term whose appearance ratio in the first component exceeds a threshold and a second term whose appearance ratio in the first component is not more than the threshold; extracting a set of structured documents each having the first component including the first term and the second component from the plurality of structured documents; and ranking of the set of structured documents by a retrieval score calculating based on a relation between the second term and the second component

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of a first embodiment of a structured document retrieval apparatus.

FIG. 2 is a diagram showing an example of a structured document.

FIG. 3 is a diagram showing the structured document shown in FIG. 2 described in a tree structure.

FIG. 4 is a diagram showing an example of a data structure stored in a structured document memory.

FIG. 5 is a diagram showing an example of a data structure stored in an index data memory.

FIG. 6 is a flowchart showing a process of an indexing unit.

FIG. 7 is a flowchart showing a process of a component categorizing unit.

FIG. 8 is a diagram showing an example of a data structure stored in a component category data memory.

FIG. 9 is a diagram showing an example of a data structure stored in a component categorized vocabulary memory.

FIG. 10 is a flowchart showing a process of a retrieval term categorizing unit.

FIG. 11 is a flowchart showing a process of a document set extraction unit.

FIG. 12 is a diagram showing a calculating formula of a retrieval score.

FIG. 13 is a block diagram of a second embodiment of a structured document retrieval apparatus.

FIG. 14 is a flowchart showing a process of a pseudo-relevance feedback.

FIG. 15 is a diagram showing a calculating formula for of a related term candidate score.

FIG. 16 is a block diagram showing other structure examples of a related term extraction unit.

FIG. 17 is a flowchart showing a process of a related term acquisition unit.

FIG. 18 is a diagram showing an example of a screen configuration provided on a related term providing unit.

FIG. 19 is a diagram showing an example of a flow of retrieval process according to the second embodiment.

### DETAILED DESCRIPTION OF THE INVENTION

The following explains the embodiments of the present invention in detail with reference to the drawings.

### First Embodiment

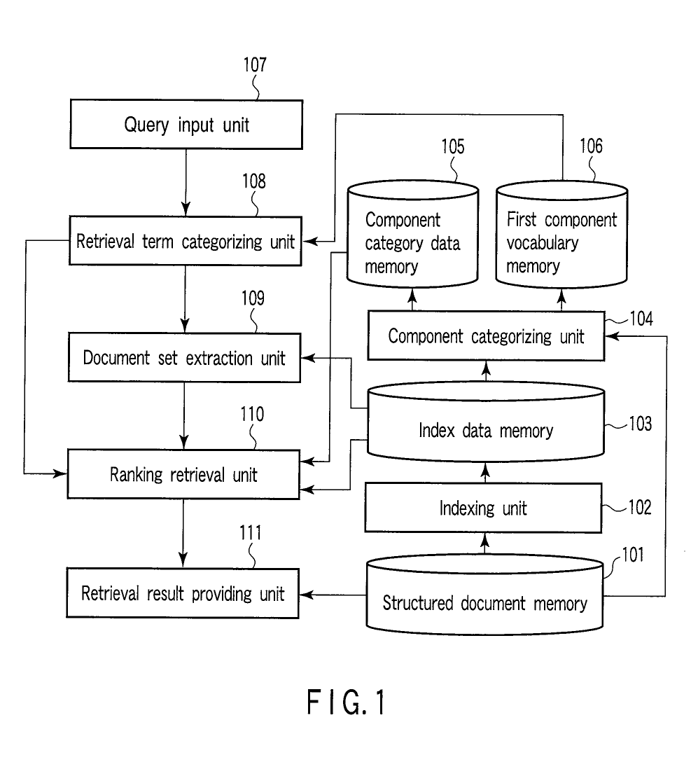

In FIG. 1, a structured document memory 101 stores a plurality of structured documents which each comprises a plurality of components including text data. The structured documents are, for instance, written in XML (extensible Markup Language). The structured documents are kept in the structured document memory 101 in a form that can obtain text data in units of component.

An indexing unit 102 reads out the structured document stored in the structured document memory 101. The indexing unit 102 extracts an index term for document retrieval from a text data of each component of the structured document by using a technique such as a morphological analysis. The indexing unit 102 generates an index data that the index term corresponds to a component of an extraction source document.

An index data memory 103 stores the index data generated by the indexing unit 102 in a form in which the index term can obtain a component of the document from which the index term has appeared.

A component categorizing unit 104 scans the text data of the structured document stored in the structured document memory 101 for each component and categorizes the components into a first component of a typical description and a second component of an atypical description, based on statistics information obtained from the text data. For example, when the average value of a character string length of the text data is shorter than a threshold, the component is categorized as the first component, and if otherwise, the component is categorized as the second component. Further, the component categorizing unit 104 generates a list of structural vocabulary for the first component using, for example, morphological analysis.

A component category data memory 105 stores the types of components categorized by the component categorizing unit 104 in a form that can be obtained by the name of the components.

A first component vocabulary memory 106 stores the list of structural vocabulary of the first components generated by the component categorizing unit 104.

A query input unit 107 receives input of a query including a retrieval character string described in a keyword or sentence form.

A retrieval term categorizing unit 108 categorizes the retrieval term included in the retrieval character string input in the query input unit 107 with reference to the first component vocabulary memory 106. The retrieval term is categorized into a first retrieval term whose appearance ratio in the first component exceeds a threshold and a second retrieval term whose appearance ratio is not more than the threshold. The first retrieval term is provided to a document set extraction unit 109, and the second retrieval term is provided to a ranking retrieval unit 110.

The document set extraction unit 109 extracts a set of structured documents each having the first component including the first retrieval term and the second component from the plurality of structured documents stored in the structured document memory 101. For example, the document set extraction unit 109 extracts the structured documents to be the retrieval target in the ranking retrieval unit 110 by using a retrieval formula generated based on the first retrieval terms and the first components in which the terms appear.

The ranking retrieval unit 110 ranks the structured documents of the set in accordance with the retrieval score representing a relation between the second retrieval term provided from the retrieval term categorizing unit 108 and the second component in the set of documents. In other words, the structured documents extracted by the document set extraction unit 109 become the retrieval target, and the ranking retrieval process is performed on the portions categorized as the second components among the components of the documents thereof, by using the above second retrieval terms. The retrieval score is, for example, calculated with regard to the set of the structured documents, based on the frequency of appearance of the second retrieval term in the text data of the second component and the number of structured documents in which the second retrieval term appears in the text data of the second component.

A retrieval result providing unit 111 provides the results retrieved by the ranking retrieval unit 110.

Further, this structured document retrieval apparatus can be realized by a computer which is provided with, for example, a CPU, memory and disk device. The structured document memory 101, the index data memory 103, the component category data memory 105 and the first component vocabulary memory 106 are adapted as data in the disk device. Further, each processing unit is realized by a control program executed on the memory by the CPU. The query input unit 107 is provided with an input device such as a keyboard. The retrieval result providing unit 111 is provided with a display device.

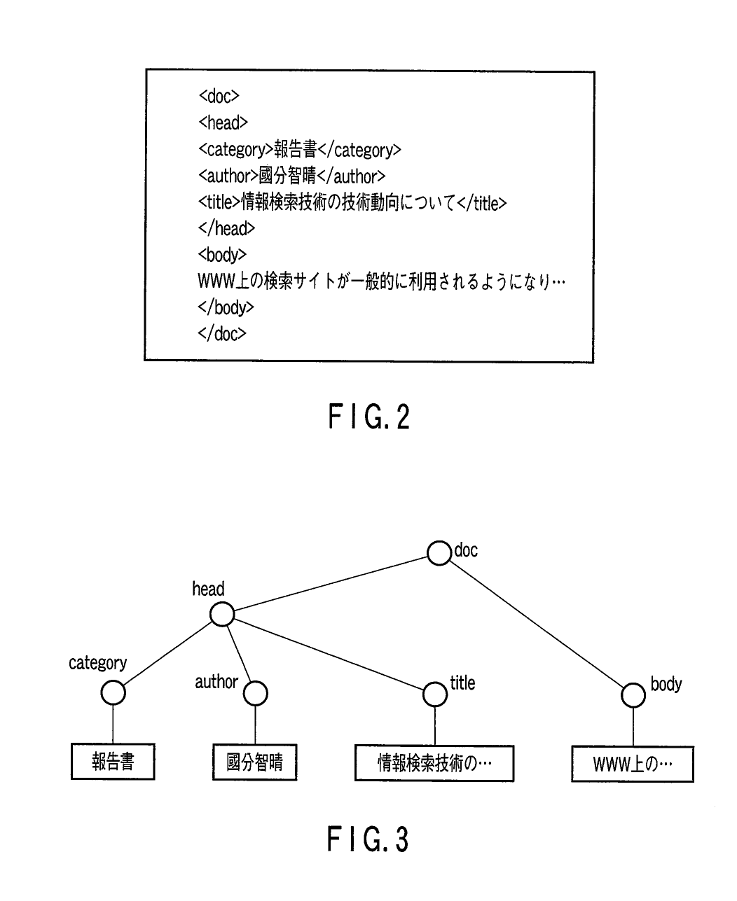

As exemplified in FIG. 2, the structured document being the retrieval target in the present embodiment has the document structure described in XML.

The structured document shown in FIG. 2 can be converted into a tree structure as shown in FIG. 3. In FIG. 3, each node represents a component, and a leaf (end node) represents text data in each component. Here, the name of the component is described in the form of joining names of tags described on the path from the route of the tree structure (the top node) to the component by “/”. In the example of FIG. 3, the following six types become the components of the structured documents.

doc

doc/head

doc/head/category

doc/head/author

doc/head/title

doc/body

Further, in the example of FIG. 3, a text data only exists in the leaf. However, a text data may also exist in the route of the tree or an intermediate node, i.e., in portions of “doc” or “doc/head”.

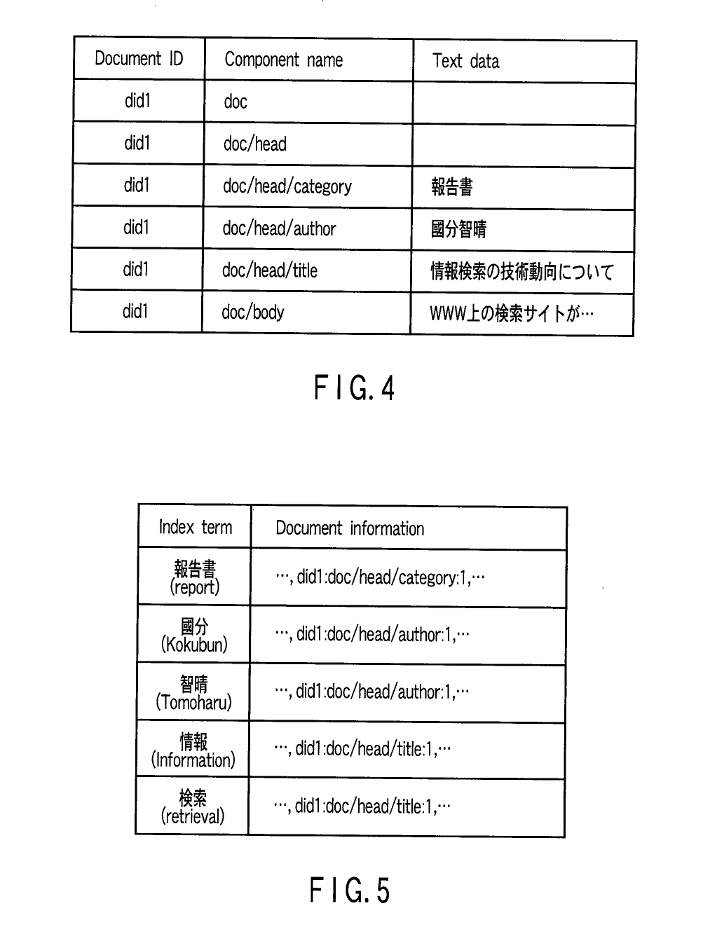

The structured document memory 101 stores the structured document exemplified in FIG. 2 in a table format as shown in FIG. 4. A document ID is an identification data for identifying the structured documents individually. FIG. 4 shows the case in which “did1” is given as a document ID with respect to the structured document in FIG. 2. A component name is a name of the components in the format explained above and has a function to identify each component of the structured document. A text is a text data in each component. In the structured document of FIG. 2, since there is no text data in “doc” and “doc/head”, the corresponding portions are made blank. Further, documents having different document structures can also be mixed in the structured document memory 101.

As shown in FIG. 5, the index data generated by the indexing unit 102 is described in a table format, in which the index term for retrieval and information of the document in which the index term appears are correlated. The information of the document in which the term appears is described in units of components, and is described by a set of a document ID of a document in which the index term appeared, a component name and an appearance frequency showing the number of times the index term appeared in the component. For example, as shown in FIG. 5, a document information includes a set of “document ID: component name: appearance frequency” is separated by commas and listed.

The operation of the structured document retrieval apparatus which is configured in the above manner will be explained in the following.

(Data Indexing Process)

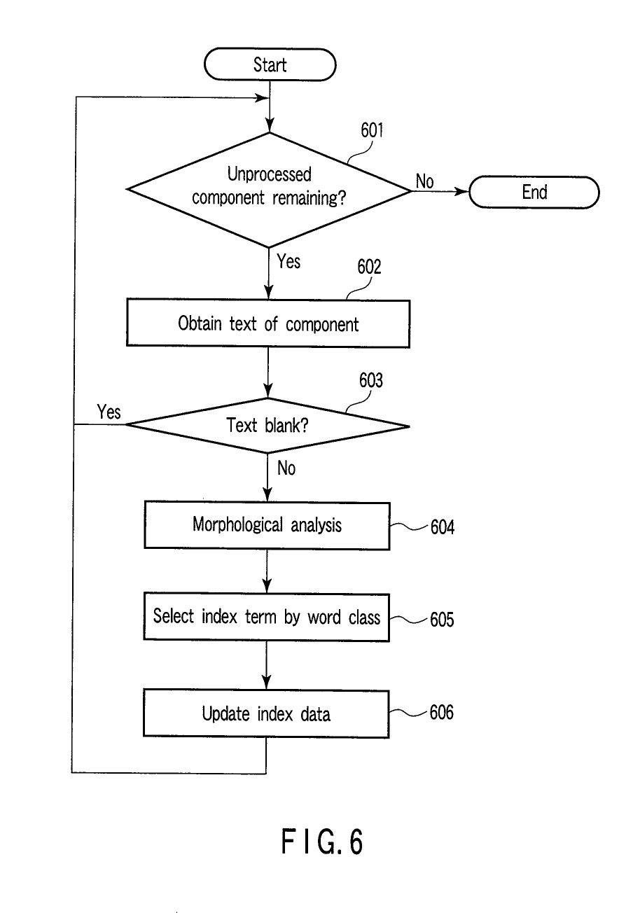

The indexing unit 102 generates an index data based on the structured document stored in the structured document memory 101, in accordance with the flowchart shown in FIG. 6.

In FIG. 6, the indexing unit 102 reads out the data in form of FIG. 4 from the structured document memory 101 in units of components and performs the process described hereinafter. The process ends when there are no more components to be processed (Block 601).

The indexing unit 102 obtains a text data of the component from the read out data (Block 602). In the case where there is a blank in the text data, i.e. when there is no text for the corresponding component as in the case of “doc” and “doc/head”, the process proceeds directly to Block 601 and moves on to the processing of the next component (Block 603). In the case where there is a text data, the indexing unit 102 divides the text data into units of terms by morphological analysis (Block 604) and selects an index term to be used upon retrieval from among the terms based on their word class (Block 605).

Further, since morphological analysis is a common technique as a natural language processing base, here, detailed explanations will be omitted. In morphological analysis, the text data is divided into units of terms, and the result of determining the word class of each term is output. For example, with respect to [symbol] [symbol] (technological trend of information retrieval technique)”, a result such as [symbol] [symbol] (information) <noun>/ [symbol] (retrieval) <noun>/ [symbol] (technique) <noun>/ [symbol] (of) <auxiliary>/ [symbol] (technique) <noun>/ [symbol] (trend) <noun>” is output. Here, “/” describes a break between terms, and “< >” describes the result of determining the word class of each term. From the result of this morphological analysis, only the term of a predetermined word class, which excludes conjunctives, for instance, only the noun, or the noun and verb are selected as an index term.

Each time the index term is selected in Block 605, the indexing unit 102 updates the index data shown in FIG. 5 (Block 606). In other words, if the selected index term is not in the index data, the indexing unit 102 adds a new line and stores such index term. For example, in a document such as document ID “did1”, if the index term [symbol] which is selected from the text data of the component “doc/head/title” is not in the index data, a line which describes the index term as [symbol] and the information of a document in which the term appears as “did1:doc/head/title:1” is added to the index data.

Further, with regard to the index term already existing in the index data, information of the document in which the term appears is updated. In the case where information regarding the component in which the index term appears and its document, i.e. “document ID: component name”, is not stored as an appearance position information of the index term, such information is added. In the above example, the index term [symbol] is registered in the index data. However, for example, if “did1:doc/head/title” is not registered as its appearance position information, “did1:doc/head/title:1” is added as an appearance position information of [symbol] and the appearance position information of [symbol] is updated as follows.

[symbol] “did1:doc/head/title:1”

In the above manner, the appearance position information of [symbol] is updated.

Further, if the index term and the appearance position information already exist, the appearance frequency of the corresponding appearance position is incremented. For example, in the case of selecting the second [symbol] in the above example, [symbol] <noun>/ [symbol] <noun>/ [symbol] <noun>/ [symbol] <auxiliary>/ [symbol] <noun>”, as an index term, since a data such as [symbol] did1:doc/head/title:1, already exists in the index data, the appearance frequency of “did1:doc/head/title” is incremented, and the data is updated as follows.

[symbol] did1:doc/head/title:2

The indexing unit 102 stores the above processed result in the index data memory 103.

(Component Analyzing Process)

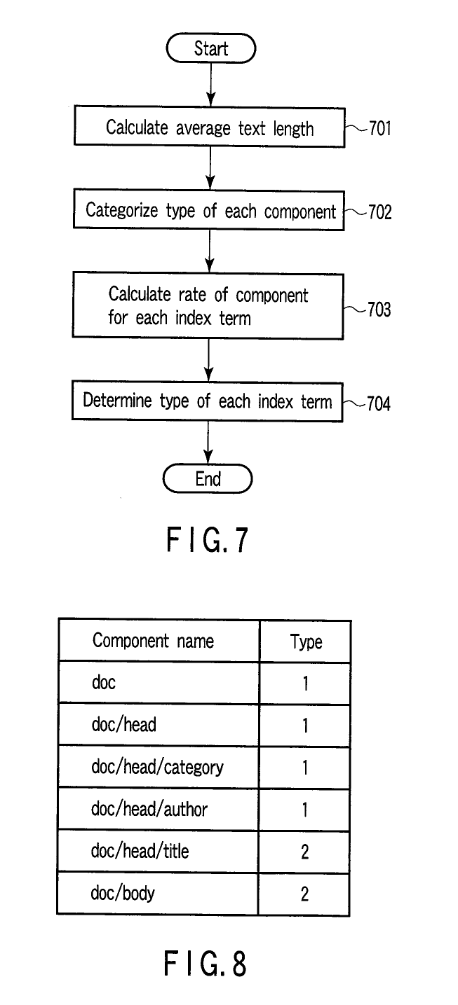

The component categorizing unit 104 categorizes each component into a first component of typical descriptions and a second component of atypical descriptions based on statistics information for each component with reference to the structured document memory 101, in accordance with the flowchart shown in FIG. 7. Furthermore, for the first component, vocabularies which construct the text data of the component are extracted.

In FIG. 7, firstly, the component categorizing unit 104 refers to the structured document memory 101 and obtains an average text length of each component for each of the structured documents as statistics information (Block 701). For instance, when there is a structured document comprising the following text data in the portion of the component “doc/head/title” in the structured document memory 101, the average text length with regard to the component “doc/head/title” calculated in units of characters would be (11+18+7)/3=12.0.

did1 doc/head/title

[symbol]

[symbol]

did2 doc/head/title

[symbol]

[symbol]

[symbol]

did3 doc/head/title

[symbol]

When the average text length for other components is calculated similarly, each component included in the structured document exemplified in FIG. 2 can be obtained as follows.

| | |
|---|---|
| Doc | 0.0 |
| doc/head | 0.0 |
| doc/head/category | 3.0 |
| doc/head/author | 3.8 |
| doc/head/title | 12.0 |
| doc/body | 1023.4 |

Each component is categorized by comparing the average text lengths obtained in the above manner with a predetermined reference value. In the case where the average text length is less than the reference value, the component is categorized as the first component. In the case where the average text length is not less than the reference value, the component is categorized as the second component (Block 702). For example, in the case where the reference value is predetermined as eight characters, in the above example, “doc”, “doc/head”, “doc/head/category” and “doc/head/author” are categorized as the first component, and “doc/head/title” and “doc/body” are categorized as the second component. The component categorizing unit 104 then stores this categorizing result in the component category data memory 105 by correlating it with the component name, as shown in FIG. 8. In FIG. 8, the type of component is described as “1” for the first component, and “2” for the second component.

Furthermore, the component categorizing unit 104 calculates the ratio of each index term in the index data memory 103 appearing in each of the first component and the second component in accordance with this categorizing result (Block 703). For example, in the case where the information of the document in which the term appears with regard to the index term [symbol] is as follows, the appearance ratio of the index term in each component type is obtained by first summarizing the number of times the index term appeared in each component.

did1:doc/head/title:2,did1:doc/body:1,did4:doc/head/title:1,did5:doc/head/cateogory:1

In the example of the above [symbol] the number of appearances would be as follows.

| | |
|---|---|
| doc/head/title | 2 |
| doc/body | 1 |
| doc/head/category | 1 |

On the basis of this summarized result, the component categorizing unit 104 refers to the categorizing result of the component stored in the component category data memory 105 to obtain the number of times the term appeared in each of the first component and the second component, and calculates the ratio of term appearance in each component. For example, regarding the index term [symbol] as “doc/head/title” and “doc/head/category” are the first components, the number of appearances in the first component is three times, and as “doc/body” is the second component, the number of appearances in the second component is once. Based on these values, the ratio of the index term [symbol] appearing in the first component and the second component are calculated respectively as 3/(3+1)=0.75 and 1/(3+1)=0.25.

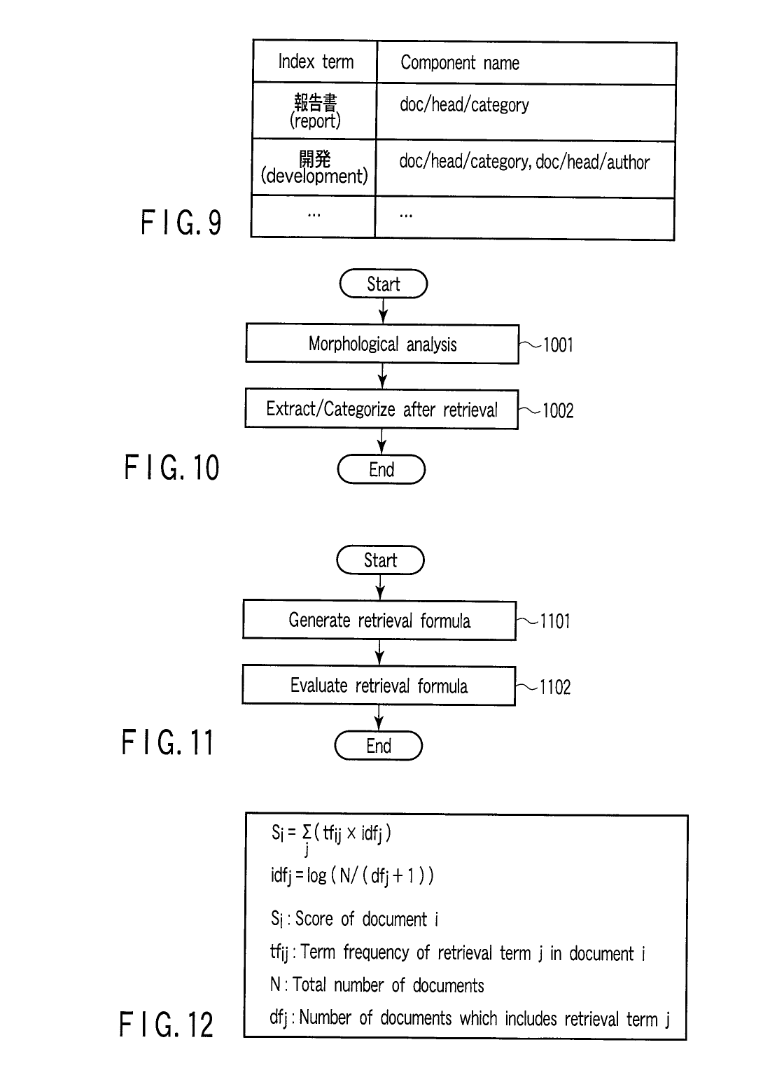

After calculating the term appearance ratio of each index term in each of the first component and the second component, the component categorizing unit 104 selects index terms whose appearance ratios are higher than a predetermined value in the first component. The selected index terms are stored in the first component vocabulary memory 106 with the component name in which they appear (Block 704). For example, with regard to [symbol] in the case where its appearance ratio in the first component is 0.95, and its appearance in the first component is only in “doc/head/category” (it is assumed to appear in the second components “doc/head/title” and “doc/body” in the ratio of 0.05), when setting the reference value as 0.9, the above mentioned [symbol] would not be selected. However, [symbol] would be selected and would be stored in the first component vocabulary memory 106 with the component name “doc/head/category” of the first component in which it appeared, in the format shown in FIG. 9.

In the example of FIG. 9, [symbol] (development)” would also be stored in the first component vocabulary memory 106 along with the [symbol] as having an appearance ratio equal to or more than 0.9 in the first component. Further, FIG. 9 shows the case in which [symbol] only appears in “doc/head/category”, and [symbol] appears in “doc/head/category” and “doc/head/author” in the first component. In the case where the term appears in a plurality of components, the component names are cited by being separated by “,”, as in the case of [symbol] in FIG. 9.

Further, in the above, the components were categorized into two types based on the length of the entire text data of each component. However, the components may also be categorized by dividing the text data by a predetermined delimiter (referred to as a unit text hereinafter), such as a blank or a linefeed, and categorizing them by the average length of the unit text, in accordance with the predetermined reference value. By setting the average length of unit text as a reference, components in which terms such as category codes are cited in delimiters such as blanks and linefeeds can be determined as the first component.

Alternatively, it is also fine to perform morphological analysis with respect to the text data of each component and divide the number of vocabularies which differs for each component (the numbers indicating how many types of terms are used in the component) by the number of documents in which the component appeared to obtain the number of average vocabularies as statistics information. If the number of average vocabularies in the component is less than the predetermined reference value, it can be categorized as the first component, and if it is not less than the reference value, it can be categorized as the second component.

Furthermore, even if the component is determined as the second component in the above, it can be determined as the first component if its vocabulary matches a vocabulary in a dictionary compiling typical descriptions prepared in advance, or if its contents match notation patterns which are templates of typical descriptions, by a ratio equal to or higher than a certain ratio. As for the dictionary, names of places and names of people etc. can be considered. As a notation pattern, patterns which can extract descriptions of amount of money or time and date etc. as follows can be prepared.

<number string> [symbol] (yen) pattern 1

<number string> [symbol] (year) <number string> [symbol] (month)<number string> [symbol] (day) pattern 2

[symbol]

(corporation)<proper noun> pattern 3

<name of place>[<name of place> . . . ][<number string><numerative> . . .] pattern 4

In the above pattern, the <number string> describes the alignment of Arabic numerals or Chinese numerals, and <proper noun>, <name of place> and <numerative> are word classes determined by morphological analysis. [symbol] and [symbol] in an address are determined as <numerative>. In addition, “[” and “]” in pattern 4 describe portions which can be omitted, and “ . . . ” therein describes that the preceding term of word class is repeated in arbitrary number of times. Morphological analysis is performed with regard to the character string in each component. The result thereof is collated with the above pattern.

For example, this will be explained with regard to a character string of 22 characters as follows.

[symbol]

[symbol]

[symbol]

The following is a result of morphological analysis of the above character string.

[symbol] <noun>/ [symbol] <noun>/ [symbol] <proper noun>/(<symbol>/ [symbol] <name of place>/ [symbol] <name of place>/ [symbol] <name of place>/-(number)/ [symbol] <numerative>/1<number>/ [symbol] <numerative>/1<number>/ [symbol] <numerative>/) <symbol>

When collating with the above pattern, the following portion can also be collated with pattern 3.

[symbol] <noun>/ [symbol] <noun>/ [symbol] <proper noun>

Further, the following portion can be collated with pattern 4.

[symbol] <name of place>/ [symbol] <name of place>/ [symbol] [symbol] <name of place>/-<number>/ [symbol] <numerative>/1<number>/ [symbol] <numerative>/1<number>/ [symbol] <numerative>

As a result, regarding the above character string, 20 characters excluding “(” and “)” among the 22 characters, i.e. portions regarding 20 characters/22 characters ≈91%, are considered as being collated with the above patterns. For example, a component whose average text length is 20 characters or more is assumed to be categorized as the second component. Even in this case, when the character string could be collated with the typical description dictionary pattern more than 80%, the character string is determined as the first component. Therefore, even if the average text length of the component including [symbol] [symbol] [symbol] exceeds 20 characters, the character string is determined as the first component, if the average collation ratio is not less than 80%.

In this manner, as statistics information for categorizing the components into the first component and the second component, it is also fine to use the matching ratio between the vocabularies in the text data of the component and the vocabularies in the dictionary compiling typical descriptions, or the matching ratio between the notation pattern of the text data of the component and the notation pattern of the template of the typical description prepared in advance.

As a technique to determine a particular type of description by collating with a dictionary or a pattern, there is a unique description extraction technique. The unique description extraction technique is a well-known technique disclosed in JP-A 2007-148785 (KOKAI). The present embodiment is not limited to the above method, and may apply the unique description extraction technique and determine as the first structural segment the character string that the ratio of characters extracted as the unique description is more than a certain ratio. Furthermore, the present embodiment uses not only the collation ratio but also a certainty ratio as mentioned in the above reference as a reference and may use as the reference the ratio of characters that could be collated with the dictionary pattern over a certainty value.

Further, contrarily, even if the component is once determined as the first component, when a particular type of vocabulary appears in a ratio equal to or higher than a certain ratio, such component may be determined as the second component. For example, regardless of the text length etc., a component may be determined as the second component if the appearance ratio of a word class included in a text data, for instance, the appearance ratio of an adjunct such as <auxiliary> or a connective such as <conjunction>, is equal to or higher than a certain value.

For example, the length of a character string such as [symbol] [symbol] (proper noun extraction apparatus and method)” is short. However, when performing a morphological analysis, [symbol] (and)” is determined as a <connective>. Therefore, the adjunct ratio becomes 3 characters/13 characters ≈23%. This is comprised of a short character string such as like a title. However, for a component which is suitable for being a ranking retrieval target, it is effective to use this method. A first component is comprised of a relatively short character string. However, for a component which is suitable for being a ranking retrieval target, it is effective to use this method.

Further, it is also fine to use a parent-child relationship of the component to categorize the type of component. For example, if a component (say, a/b) can be categorized as the second component, the component of its descendant (such as a/b/c or a/b/d/e) may also be categorized as the second component. In this manner, a component to describe a font attribute such as an underline or a bold face in a sentence can be categorized as a second component.

(Retrieval Term Categorizing Process)

In accordance with the flow chart shown in FIG. 10, the retrieval term categorizing unit 108 extracts a retrieval term to be used for retrieval processing from a query input by a user and categorizes this retrieval term to a first retrieval term to be used in the document set extraction unit 109 and a second retrieval term to be used in the ranking retrieval unit 110 in a latter stage.

Firstly, the retrieval term categorizing unit 108 performs a morphological analysis with respect to a retrieval character string of the query input by the query input unit 107 and divides it into units of terms (Block 1001). The retrieval term categorizing unit 108 extracts the retrieval term based on the result of the morphological analysis (Block 1002). In the extraction of the retrieval term, first, the first component vocabulary memory 106 is referred upon to categorize the terms listed therein as the first retrieval term to be used in the document set extraction unit 109.

The first retrieval term categorized above is correlated with the component name of the first component in which it appears, and is provided to the document set extraction unit 109 in a format of “retrieval term : component name, component name, . . . ”. Meanwhile, the second retrieval term to be used in the ranking retrieval unit 110 is selected based on the word class, likewise the process of Block 605 in the above FIG. 6, from the terms which were not categorized as the first retrieval term in the above categorization. The second retrieval term is provided to the ranking retrieval unit 110 as a list of terms.

For example, for a query such as [symbol] [symbol] (report about the information retrieval)”, the result of a morphological analysis (Block 1001) turns out as follows.

[symbol] <noun>/ [symbol] <noun>/ [symbol] <auxiliary>/ [symbol] <sa-conjugate verb>/ [symbol] <noun>

In this query, since [symbol] is in the first component vocabulary memory 106, [symbol] is correlated with the component name “doc/head/category” in which it appears and is provided to the document set extraction unit 109. With regard to the other terms, in the case of selecting only the nouns as the retrieval term, [symbol] and [symbol] are provided to the ranking retrieval unit 110.

In the above example, the second retrieval term is categorized by excluding the first retrieval term. However, it is also fine to have the first retrieval terms and the second retrieval terms overlap. For example, in the above, the second retrieval term is categorized by excluding [symbol] which is categorized as the first retrieval. However, it is also fine to categorize the second retrieval term without excluding [symbol] By doing so, [symbol] would be extracted as the second retrieval term since it is also a noun. Therefore, [symbol] and [symbol] would be provided to the ranking retrieval unit 110. Since the appearance ratio of [symbol] in the second component is not 0, the above allows improvement in recall ratio of retrieval in comparison to the case of excluding.

(Document Set Extracting Process)

In accordance with the flow chart shown in FIG. 11, the document set extraction unit 109 generates a retrieval formula of a Boolean format based on the first retrieval term and the component name provided from the above retrieval term categorizing unit 108, and refines a retrieval target document of the ranking retrieval unit 110 according to the retrieval formula.

The retrieval formula is expressed in a form of “structural segment name=‘retrieval term’”, that is, in a form that items for limiting a document which the retrieval term appears in the structural segment are coupled by a logical operator, e.g. an AND (logical addition) gate or OR (logical product)) gate. In principle, the operators are evaluated in order from the left. However, when there are portions parenthesized by ‘(’ and ‘)’, such portions are evaluated preferentially.

The document set extraction unit 109 generates the retrieval equation based on the following rules (Block 1101).

Rule 1: If a plurality of components is correlated to an identical retrieval term, a formula which connects “component name=‘retrieval term’” by “OR” is parenthesized by ‘( )’. If there is only one component correlated to the retrieval term, only “component name=‘retrieval term’” is generated.

Rule 2: In the case where a plurality of retrieval formulas is generated in Rule 1, all of such formulas are connected by “AND”.

For example, in the case where only [symbol] doc/head/category” is provided from the retrieval term categorizing unit 108, the retrieval formula “doc/head/category= [symbol] is generated by Rule 1. In this case, since only one retrieval term is provided from the retrieval term categorizing unit 108, Rule 1 generates only one retrieval formula, and Rule 2 is not applied.

In the case where a plurality of retrieval terms such as [symbol] doc/head/category, doc/head/author” in addition to [symbol] doc/head/category” are provided, Rule 1 generates “(doc/head/category= [symbol] OR doc/head/author= [symbol] in addition to “doc/head/category= [symbol] which are connected by “AND” by Rule 2, thereby, generating the following (formula 1) as a conclusive retrieval formula.

doc/head/category= [symbol] AND (doc/head/category= [symbol] OR doc/head/author= [symbol] (Formula 1)

Rules for the document set extraction unit 109 to generate a retrieval formula is not restricted to Rule 1 and Rule 2. For example, it is conceivable to establish other rules such as a rule of jointing by “OR” the retrieval formulas in which the components to be referred upon in the retrieval formulas overlap, when a plurality of retrieval formulas are generated by Rule 1.

The document set extraction unit 109 evaluates the retrieval formula generated in this manner and extracts a set of the structured documents as retrieval target documents (Block 1102). For example, when the information of the document in which the index data of [symbol] appears is: did1:doc/head/category:1, did7:doc/head/category:1, did9:doc/head/category: 1, . . .

in the index data memory 103, the evaluation result of the retrieval formula “doc/head/category= [symbol] becomes documents {dic1, dic7, dic9, . . . } in which [symbol] appears in “doc/head/category”.

Similarly, when the index data of [symbol] is: [symbol] did1:doc/body:3, did3:doc/head/category:1, did7:doc/head/author:1, . . . ,

the evaluation result of the above (Formula 1) becomes:

{did1, did7, did9, . . . } AND ({did3, . . . } OR {did7, . . . })={did1, did7, did9, . . . } AND {did3, did7, . . . }={did7, . . . }.

In such manner, the set of the structured documents extracted as retrieval targets are provided to the ranking retrieval unit 110 in a format of a list of document ID.

(Ranking Retrieval Process)

The ranking retrieval unit 110 performs a ranking retrieval (a document retrieval which ranks documents by the retrieval score) with respect to the structured documents of the set extracted by the document set extraction unit 109. As a ranking retrieval scheme, techniques of such as a vector space model or a probability model are proposed. However, here, the retrieval results are output in descending order of the scores based on retrieval scores of documents, which is known as a tf·idf scheme.

In the tf·idf scheme, the retrieval score of a document is calculated by the sum of products of tf (term frequency) of each retrieval term appearing in the document and idf (inverse document frequency) which is calculated on the basis of the number of documents in which the retrieval term appears. In other words, the retrieval score of the document is calculated in accordance with the formula shown in FIG. 12.

For example, in the case where [symbol] and [symbol] are provided to the ranking retrieval unit 110 by the retrieval term categorizing unit 108 as second retrieval terms, and the index data of [symbol] and [symbol] in the index data memory 103 is as follows, term frequency of [symbol] in document “did1” can be calculated as 1+5=6, and term frequency of [symbol] can be calculated as 1+3=4.
[symbol] . . . , did1:doc/head/title:1, did1:doc/body:5, . . .
[symbol] . . . , did1:doc/head/title:1, did1:doc/body:3, . . .

Further, when the total number of documents N is 256 documents, the document frequency df of [symbol] are 31 documents, and document frequency df of [symbol] are 15 documents, the idf of [symbol] becomes log (256/(31+1))=3.0, and the idf of [symbol] becomes log (256/(15+1))=4.0. The score S of document “did1” in this case is calculated as follows (the base of log is 2).

3.0*6+4.0*4=34.0

The document in which each index term appears can be obtained by referring to the index data in the index data memory 103 and counting the types of documents in which the index term appeared. In this manner, the retrieval result providing unit 111 provides the retrieval result by listing the document ID, the retrieval score and the document summary of the second component in descending order of the retrieval score. As a matter of course, the calculation of the retrieval score is not restricted to the tf·idf scheme. Therefore, the retrieval score may be also calculated by other schemes.

In the document summary, the text of the second component is obtained from the structured document memory 101 in the order exemplified in FIG. 4. Then, for instance, a given number of character strings (each including, for example, 10 characters) are acquired before and after the appeared retrieval term appears within the range of predetermined number of characters (for example, 100 characters). The character strings are generated in a form of being jointed to one another by “/”. By referring to the component category data memory 105, the text of the second component for a desired document can be easily obtained from the structured document memory 101. For example, the summary result of document “did1” with respect to retrieval terms [symbol] and [symbol] is as follows.

[symbol]

[symbol]

[symbol]

[symbol]

[symbol]

. . .

(Summarizing Process)

A summarizing process is carried out with regard to the second component text data in the following procedure.

Step 1: A portion in which a retrieval term appears next in the text (in the case of carrying out this step at the beginning, a portion in which it appears first) is retrieved. If there are no portions in which the term appears, the process is ended.

Step 2: 10 characters before and after the retrieval term is cut out as a summary.

Supplementation 2-1: In the case where there is a borderline of a component within before and after the 10 characters, the characters beyond the borderline are not output.

Supplementation 2-2: In the case where it exceeds 100 characters when adding the cutout text to the text which is being summarized, the process is ended.

Supplementation 2-3: In the case where the cutout text is included in the text which is being summarized, the procedure returns to step 1 and moves on to retrieving the next portion.

Supplementation 2-4: In the case where the text which is being summarized is included in the cutout text, the text is deleted from the summary (the delimiter ‘/’ is deleted arbitrarily).

Step 3: If the summary is not blank, the text cut out in step 2 is added to the summary by delimiting it by a delimiter ‘/’ (if blank, the text is simply placed to the top of the summary). The procedure then returns to step 1.

Taking the document shown in FIG. 4 as an example, the portions in which the retrieval terms [symbol] and [symbol] appear are checked in order from the top of the second component, that is, in the order of “doc/head/title”, “doc/body”. With respect to the document of “did1”, firstly, the portion in which the retrieval term appears in [symbol] [symbol] of the component “doc/head/title” is retrieved. The retrieval term [symbol] appears at the top, and 10 characters before and after the term are cut out in accordance with the above step 2 and added to the summary. Since [symbol] is at the top of the component “doc/head/title”, the subsequent 10 characters are cut out, and the [symbol] [symbol] (text A) becomes the initial value of the summary.

Next, since [symbol] appears from the third character, the text for summary is cut out similarly from the component “doc/head/title”, and the result becomes [symbol] [symbol] (text B). The two characters [symbol] preceding [symbol] and nine characters thereafter are cut out. This is because both reached the borderline of component within 10 characters. In this instance, since the cutout text B includes text A which is being summarized, text A is deleted, and text B becomes the initial value of the summary. Since there are no other portions in which [symbol] and [symbol] appear, the process regarding component “doc/head/title” is ended.

A similar process is carried out regarding component “doc/body”, and [symbol] [symbol] [symbol] is cut out from the top portion, “WWW [symbol] [symbol] [symbol] [symbol] [symbol] . This is added to the initial value of the summary cut out from the above component “doc/head/title”. Therefore, the summary of the document shown in FIG. 4 becomes

[symbol]

[symbol]

[symbol]

[symbol]

[symbol]

[symbol]

As mentioned above, in the above first embodiment, the components of each of the structured documents are categorized into the first component of typical descriptions and the second component of atypical descriptions, and the retrieval terms included in the retrieval character string are categorized into the first retrieval whose appearance ratio in the first component exceeds the threshold and the second retrieval term whose appearance ratio is not more than the threshold. After extracting a set of the structured documents having the first retrieval term included in the first component from a plurality of structured documents, a ranking retrieval is performed, in which the structured documents of the set are ranked in accordance with the retrieval score representing a relation between the second retrieval term and the second component.

Accordingly, according to the first embodiment, by generating from the query of a keyword or sentence form a retrieval formula for refining retrieval targets with respect to a structured document, a user is able to realize an accurate document retrieval by readily deleting retrieval noise without minding the document structure.

### Second Embodiment

In a second embodiment of the present invention, a related term of a retrieval character string is extracted from a certain number of top-ranked documents which were retrieved by the ranking retrieval unit 110 to re-retrieve documents matching the retrieval character string by adding it to the second retrieval term (a scheme referred to as pseudo-relevance feedback, or local feedback).

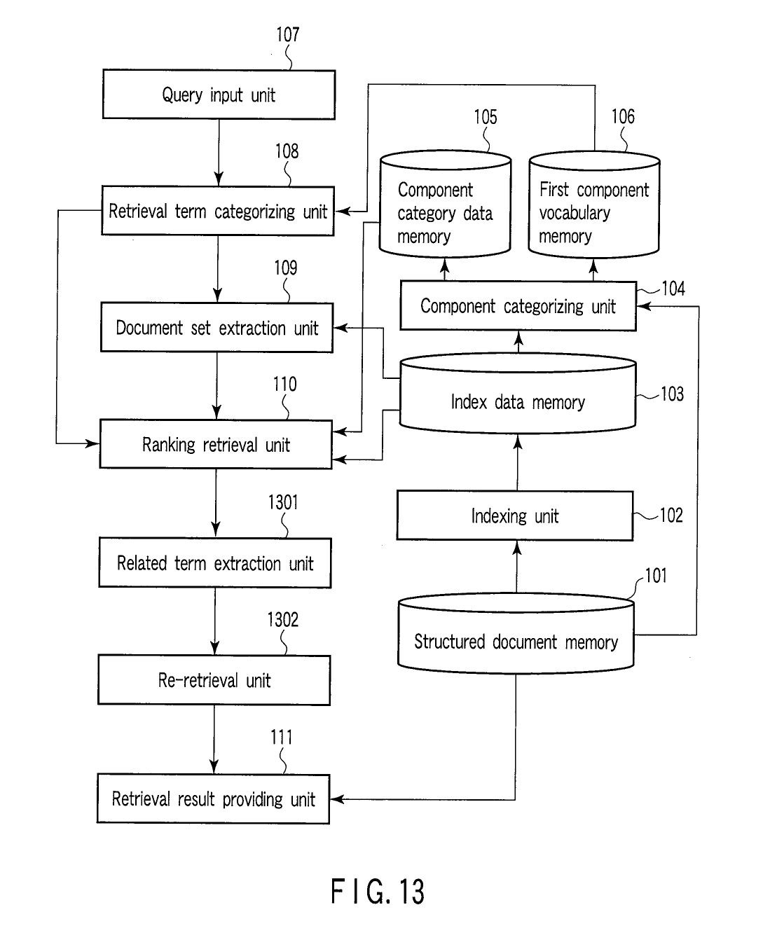

FIG. 13 shows a configuration of a structured document retrieval apparatus of the second embodiment, in which a related term extraction unit 1301 and a re-retrieval unit 1302 are added to stages subsequent to the ranking retrieval unit 110 shown in FIG. 1. Further, in FIG. 13, configurations similar to FIG. 1 will be given identical symbols and will be omitted detailed explanations.

When calculating a retrieval score of the ranking retrieval unit 110 mentioned above, the related term extraction unit 1301 extracts a plurality of related terms related to a retrieval character string based on the second component text data of top-ranked documents (result of a certain number of top-ranked documents retrieved on the basis of the second retrieval term=a certain number of documents in the top rank of initial retrieval result) retrieved by the tf·idf scheme.

The re-retrieval unit 1302 re-retrieves a document which matches the retrieval character string using the related term extracted by the related term extraction unit 1301 and the above second retrieval term.

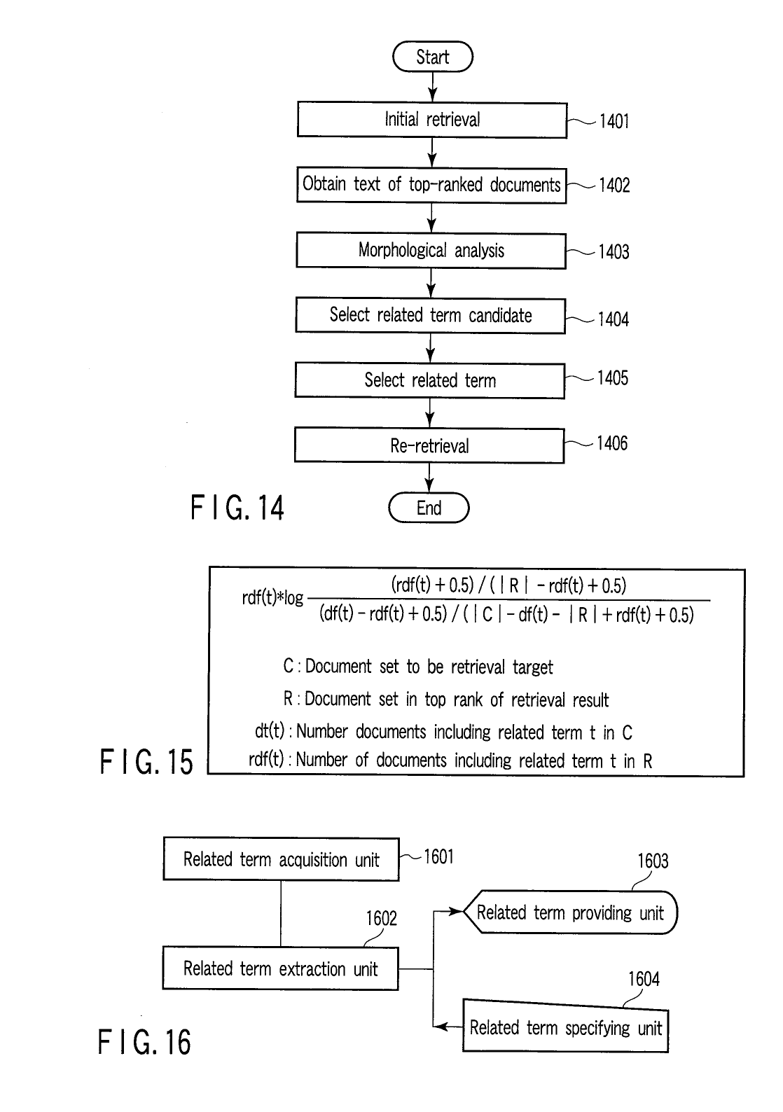

In FIG. 14, the ranking retrieval unit 110 executes an initial retrieval (a retrieval process based on the second retrieval term) on the basis of the calculating formula of the retrieval score shown in FIG. 12 (Block 1401). The related term extraction unit 1301 obtains text data which is to be the extraction source of the related terms from the top-ranked documents of this retrieval result (Block 1402). With regard to the details of pseudo-relevance feedback, refer to, for instance, “Sakai et al.: A prospect for Cross-language information retrieval using BMIR-J2, Information Processing Society of Japan report, 99-NL-129, pp. 41-48, 1999. ‘3 baseline: Japanese single language retrieval (J-MIR)’ (p.44)”. In the present embodiment, the related term extraction unit 1301 refers to the component category data memory 105 and obtains only the second component text data with regard to each of the certain number of top-ranked documents of the retrieval result, from the structured document memory 101.

The related term extraction unit 1301 performs a morphological analysis with regard to the obtained text data (Block 1403) and, likewise selecting index terms by word class as in FIG. 6 (Block 605) or extracting/categorizing retrieval terms as in FIG. 10 (Block 1002), selects candidates of related terms from the result of the morphological analysis based on the word class (Block 1404). The related term extraction unit 1301 then calculates a relevance ratio between each related term candidate selected above and query, and selects a certain number of related terms in descending order of the relevance ratio (Block 1405).

The re-retrieval unit 1302 adds the related terms selected above to the second retrieval terms provided by the above retrieval term categorizing unit 108 and performs re-retrieval based on the retrieval score shown in FIG. 12 (Block 1406).

For example, in the case where the document of “did1” appears in the top rank of the initial retrieval [symbol] [symbol] as a result of obtaining the text data of the second components “doc/head/title” and “doc/body” and performing morphological analysis etc., the following terms which are not included in the query are obtained as candidates of related terms.

[symbol] [symbol] (site), . . .

The related term extraction unit 1301 calculates the relevance ratio, including the candidates obtained from the other top-ranked documents, in accordance with the formula shown in FIG. 15 and selects a certain number of terms in descending order of relevance ratio as related terms.

As in the above mentioned second embodiment, by employing a pseudo-relevance feedback, retrieval can be performed not only on documents in which the term in the query appears but also over a wide variety of documents. Further, on such occasion, the present embodiment is able to prevent obtaining related terms which are irrelevant to document details, such as the name of an author, by excluding the first component which is fragmentary information, such as bibliographic information, and by obtaining related terms only from the second component.

In the above procedure, upon selecting related terms, text data of the second component is obtained with regard to the top-ranked document of the initial retrieval to perform morphological analysis. However, it is also fine to extract related term candidates by performing, for example, morphological analysis in advance, and store them in the structured document memory 101 by correlating them with the component of the extraction source. By doing so, related term candidates may be obtained directly based on the second component without performing the process of, for example, morphological analysis in the related term extraction unit 1301, and a certain amount of related terms would be able to be selected by the formula shown in FIG. 15. Further, the present invention may also select other known methods instead of the method of pseudo-relevance feedback which is based on the formula of FIG. 15.

In addition, in the above mentioned pseudo-relevance feedback, it is also fine to perform re-retrieval by adding only the related terms selected by a user instead of simply adding the related terms selected from the potential related terms by the related term extraction unit 1301. Specifically, the above selected related terms are presented to the user, who is, therefore, able to select the related terms to be actually used in the retrieval. On such occasion, it is also fine to obtain a certain amount of related terms for each second component and present them for each component to the user. By doing so, in the case where the roles of descriptions of purpose and assignment etc. are clear, related terms would be able to be presented to the user according to each role of each description.

In FIG. 16, likewise the related term extraction unit 1301 mentioned above, a related term acquisition unit 1601 obtains related terms for each second component in the top-ranked documents of the retrieval result obtained by the ranking retrieval unit 110.

A related term extracting unit 1602 provides the related terms obtained by the related term acquisition unit 1601 to a related term providing unit 1603 in a format which correlates the term with the component name of its acquisition source. While doing so, the related terms specified by the user via a related term specifying unit 1604 are output to the re-retrieval unit 1302.

The component name is not simply described as it is. It is provided, for example, in a corresponding table of the component name and character string for display as follows, and the related terms are correlated with the latter and provided.

| | |
|---|---|
| doc/head/title | Title |
| doc/body | Body |

The related term providing unit 1603 is comprised of an apparatus for display such as a display device. The related term specifying unit 1604 is comprised of an input device such as a mouse or keyboard.

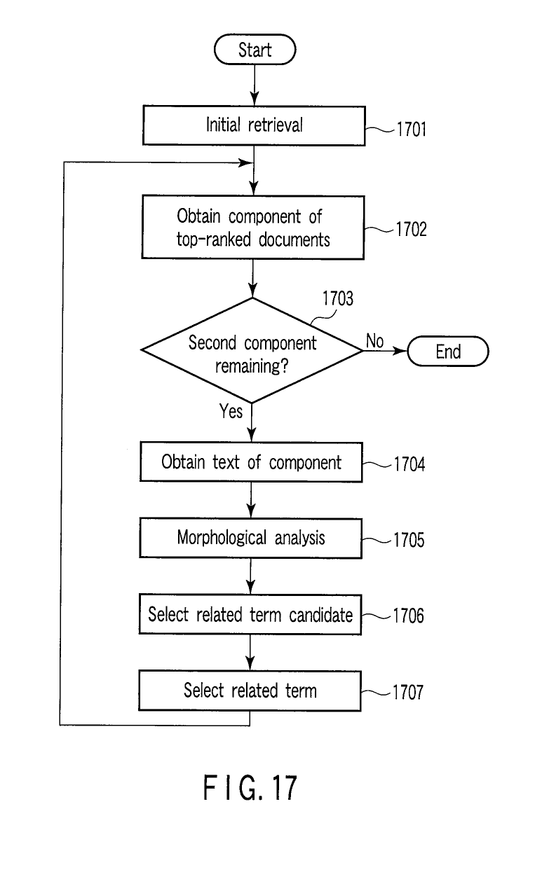

In FIG. 17, the related term acquisition unit 1601 performs initial retrieval by the ranking retrieval unit 110 likewise Block 1401 of FIG. 14 mentioned above (Block 1701). The following processes are performed for each second component with respect to the certain number of top-ranked documents of the result. Firstly, one by one, the related term acquisition unit 1601 takes out the second component name which is included in the top-ranked documents of the initial retrieval result (Block 1702). If there are no remaining unprocessed components, the related term obtaining process is ended (Block 1703). The second component name included in the top-ranked documents can be obtained by reference to the structured document memory 101 of FIG. 1 exemplified in FIG. 4 and the structured element category data memory 105 exemplified in FIG. 8. Specifically, the structured document memory 101 is referred to in order from the top rank of the initial retrieval result (Block 1701) to examine what kind of component is included in the focused document. The type of each component is determined by reference to the component category data memory 105.

In Block 1703 of FIG. 17, the related term acquisition unit 1601 keeps a list of processed component names and determines whether or not the second component being focused is processed or not based on the list. The text data included in the component which is newly determined as unprocessed is obtained for each document of the top-ranked documents (Block 1704).

The processes of morphological analysis (Block 1705), related term candidate selection (Block 1706) and related term selection (Block 1707) are similar to those of Block 1403 to 1405 in FIG. 14. The related term acquisition unit 1601 performs these processes on each text data obtained by Block 1704 and outputs the selected related term to the related term extracting unit 1602 with the component name.

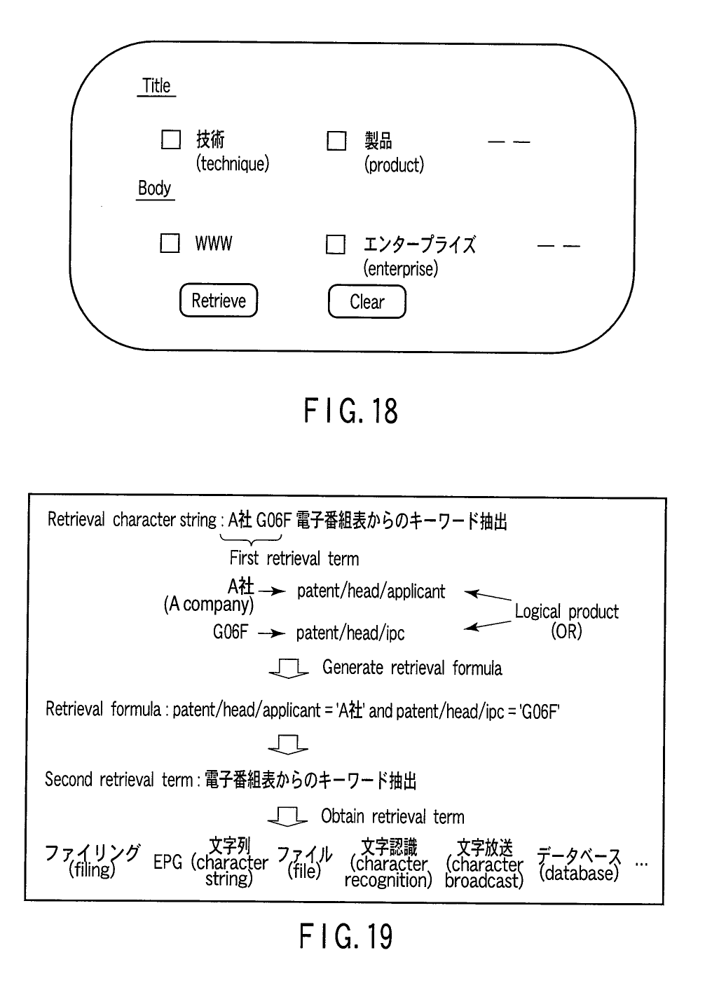

As shown in FIG. 18, in the related term providing unit 1603, the related terms obtained by the processes carried out in FIG. 17 are displayed (for “Title”, [symbol] (technique), [symbol] (product), and for “Body”, WWW, [symbol] [symbol] (enterprise)) after the name for display of the component (“Title” and “Body” in FIG. 18). Each related term is displayed with a check box used in GUI (Graphical User Interface) of, for example, a personal computer. In the example of the window in FIG. 18, when the check box is ticked by a pointing device of, for example, a mouse, the related term corresponding to the relevant check box is regarded as being selected. The “Retrieve” and “Clear” in FIG. 18 are buttons on GUI. When the “Retrieve” button is pressed, the re-retrieval unit 1302 executes the same re-retrieval process as in Block 1406 by adding the above selected related term to the second retrieval terms provided from the retrieval term categorizing unit 108. When the “Clear” button is pressed, all related terms are reset to an unselected state.

In this manner, by providing the related terms by correlating them with components, in the case where the roles of the descriptions of purpose and assignment are clear for each component, a user would be able to select related terms corresponding to the role of each description. By doing so, retrieval results in further agreement with the retrieval purpose of a user can be easily obtained.

For example, suppose a user inputs [symbol] G06F [symbol] [symbol] [symbol] as a retrieval character string in the query input unit 107 as shown in FIG. 19. The retrieval term categorizing unit 108 would categorize “A [symbol] (A company)” and “G06F” as the first retrieval term, and [symbol] [symbol] (keyword extraction from electronic program guide)” as the second retrieval term.

The document set extraction unit 109 would generate a retrieval formula as shown in FIG. 19 using the first retrieval term and extract a set of the structured documents which become retrieval targets. FIG. 19 shows an example of generating a retrieval formula with regard to the case in which “A [symbol] ” and “G06F” appear respectively in “patent/head/applicant” and “patent/head/ipc”, which are components categorized as the first component. Further, the ranking retrieval unit 110 performs ranks the documents of the set using [symbol] [symbol] which was categorized as the second retrieval term. The related term extraction unit 1301 extracts related terms from the text data of the second component in the top-ranked documents of the retrieval results of the ranking retrieval unit 110.

Accordingly, according to the first and second embodiments mentioned above, by generating from the query of keywords and sentence formats a retrieval formula for refining a retrieval target with respect to a structured document, a user is able to realize an accurate document retrieval by readily deleting retrieval noise without minding the document structure. In addition, by carrying out ranking retrieval or by obtaining related terms with respect to an appropriate range in a document, it is possible to realize improvement in retrieval accuracy and appropriate retrieval navigation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for retrieving a plurality of structured documents each comprising a plurality of components including text data, comprising:
a first categorizing unit configured to categorize the components into a first component of typical descriptions and a second component of atypical descriptions, based on statistics information for the components;
an input unit configured to input a retrieval character string including a plurality of terms;
a second categorizing unit configured to categorize the terms into a first term whose appearance ratio in the first component exceeds a threshold and a second term whose appearance ratio in the first component is not more than the threshold;
a document set extraction unit configured to extract a set of structured documents each having the first component including the first term and the second component from the plurality of structured documents; and
a ranking unit configured to rank the set of structured documents by a retrieval score calculating based on a relation between the second term and the second component.

2. The apparatus according to claim 1, wherein the statistics information includes data regarding a length of the text data included in each of the components.

3. The apparatus according to claim 1, wherein the statistics information includes data regarding a ratio of word class included in the text data included in each of the components.

4. The apparatus according to claim 1, wherein the statistics information includes data regarding the number of vocabulary types in the text data included in each of the components.

5. The apparatus according to claim 1, wherein the statistics information includes data regarding a matching ratio between a vocabulary in the text data included in each of the components and a vocabulary in a dictionary compiling typical expressions.

6. The apparatus according to claim 1, wherein the statistics information includes data regarding a matching ratio between a notation pattern of the text data included in each of the components and a predetermined notation patterns which are templates of typical descriptions.

7. The apparatus according to claim 1, wherein the retrieval score is calculated with respect to the set based on a frequency in which the second term appears in the text data included in the second component and the number of structured documents in which the second appears in the text data including the second component.

8. The apparatus according to claim 1, further comprising a providing unit which provides a summary with respect to the text data included in the second component regarding each of the ranked structured documents.

9. The apparatus according to claim 1, further comprising:
an related term extraction unit configured to extract a related term related to the retrieval character string based on the text data included in the second component comprising each of the ranked structured documents; and
a re-retrieval unit configured to re-retrieve a document matching the retrieval character string from the ranked structured documents using the related term and the second term.

10. The apparatus according to claim 1, further comprising:
an related term extraction unit configured to extract a plurality of related terms related to the retrieval character string based on the text data including the second component comprising each of the ranked structured documents; and
a re-retrieval unit which re-retrieves a document matching the retrieval character string from the ranked structured documents, using a related term selected by a user from the plurality of related terms and the second term.

11. A method for retrieving a plurality of structured documents each comprising a plurality of components including text data, comprising:
categorizing the components into a first component of typical descriptions and a second component of atypical descriptions, based on statistics information for the components;
inputting a retrieval character string including a plurality of terms;
categorizing the terms into a first term whose appearance ratio in the first component exceeds a threshold and a second term whose appearance ratio in the first component is not more than the threshold;
extracting a set of structured documents each having the first component including the first term and the second component from the plurality of structured documents; and
ranking the set of structured documents by a retrieval score calculating based on a relation between the second term and the second component.

12. A computer readable storage medium storing instructions of a computer program for retrieving a plurality of structured documents respectively comprising a plurality of components including text data, which when executed by a computer results in performance of Block comprising:
categorizing the components into a first component of typical descriptions and a second component of atypical descriptions, based on statistics information for the components;
inputting a retrieval character string including a plurality of terms;
categorizing the terms into a first term whose appearance ratio in the first component exceeds a threshold and a second term whose appearance ratio in the first component is not more than the threshold;
extracting a set of structured documents each having the first component including the first term and the second component from the plurality of structured documents; and
ranking the set of structured documents by a retrieval score calculating based on a relation between the second term and the second component.
